(19) United States
(12) Patent Application Publication
(10) Pub. No.: US 2002/0040678 A1
(43) Pub. Date: Apr. 11, 2002

(54) Machine for the automatic painting of panels or other articles

(76) Inventors: Luigi Franzoni, Imola (IT); Bruno Baroncini, Imola (IT)

Correspondence Address: LARSON & TAYLOR, PLC, 1199 NORTH FAIRFAX STREET, SUITE 900, ALEXANDRIA, VA, 22314, US

(21) Appl. No.: 09/963,656

(22) Filed: Sep. 27, 2001

(30) Foreign Application Priority Data
Oct. 11, 2000 (IT) BO2000 U 000135

(51) Int. Cl. B05C 5/00

(52) U.S. Cl. 118/314; 118/323

(57) ABSTRACT

At the interior of a working booth (1) of a painting machine with a robotized head (13), on the same guide (5) for the longitudinal and vertical movements of the said head, there is mounted a second ancillary painting head (19) similar to the one robotized, but constructively simplified in order to perform only oscillation movements for works of simple type. The ancillary spraying head is fixed at one extremity of the booth when the machine has to operate with the robotized head (13) upon panels stationary inside the same booth. Otherwise, when it has to operate upon travelling panels, the ancillary head (19) is moved to an intermediate and pre-established point of the same booth, while the robotized head (13) is placed and stopped at a distance from the ancillary head variable and correlated to the speed of travel of the panels and to the oscillating speed transversely to the same panels of both the heads, the guns of which are now actuated for performing works of simple painting. Preferably, the robotized head is provided with four guns (14) for performing simple works, and with a gun (14′) for the finishing of complex edges, while the ancillary head (19) is provided with only four guns (14) for performing simple works.

### DESCRIPTION

The invention relates to the machines for the automatic painting of panels or other flat articles, with a simple or complex shape, that are to be painted on the flat surface and if necessary also on the edges.

In this sector of the industry, the known prior art teaches the use of spraying machines capable to operate upon panels having a simple shape, in longitudinal movement inside a booth where upon the same panels there translate alternatively, in a transversal direction, with a movement usually defined oscillation, two operating heads placed between them with a prearranged distance and provided with several guns oriented in such a manner that allows to spray the paint both on the flat surface and on the lateral edges and on the anterior and posterior front edges of the panels. The relative parameters regarding the travel speed of the panels, the translation speed of the spraying heads, the distance between the said heads and the relative position of the guns, are correlated between them in such a manner that the head which operates finally on the panels, operates on the portions of surface of the same panels which have not been worked by the first head, in order to realise an uniformly distributed painting. These machines are suitable for the painting of panels with edges without recessed portions, ensure a good quality work and according to the employed guns, are capable of high productivity, with a forward travel of the product variable approximately between two and eight meters per minute.

For the painting of panels having complex shape, the prior art teaches the use of machines with guns mounted aboard a robotized head that can travel along the longitudinal axis of the booth, in transversal directions, vertical displacements and that can perform rotations along a vertical axis and if necessary also on a vertical axis. On this head are mounted guns that can perform works of simple painting, like in the painting machine above mentioned and guns dedicated to the painting of edges having a complex shape.

These machines can operate in two different manners. The head can be activated with the guns used for the performing of simple works and can be caused to oscillate transversally to the piece which is travelling, and in this case allows productions substantially reduced to the half with respect to the painting machines with two heads above mentioned, then varying from about two to four meters per minute. If, otherwise, the pieces are with a complex shape, the same are positioned and arrested at the interior of the booth and are painted by the head that moves in the different directions X and Y and from which are activated in the correct phase also the guns necessary for the complex shape, those dedicated to the edges. The shape of the piece is plotted by means of a barrier of photodiodes at the entrance of the booth or is supplied to the on-board processor by means of a CAD drawing. In this case the machine is capable to ensure a high quality of work.

In many sectors of industry it is sometime necessary to perform works of simple type and with high production, and sometime works of complex type, so that in the same operating space there should be at the same time present both the above mentioned machines, with problems of overall dimensions and with the remarkable costs of installation and of operations, which become prohibitive when the two machines operates in a discontinuous manner.

The invention intends to obviate to these inconveniences of the known art by utilising the following idea of solution. At the interior of the spraying booth of a robotized machine of the above mentioned second type, there is arranged a second ancillary head, which is similar to the robotized head, but constructively simplified so as to be capable to perform only oscillating movements for works of simple type. The secondary head is stopped at one extremity of the booth whenever the machine must operate with the robotized head onto the stationary panels. Whenever instead the machine must operate onto moving panels, the ancillary head is moved to one intermediate, fixed and pre-determined point of the booth and the robotized head is positioned automatically and is stopped at a distance from the ancillary head variable and correlated with the travel speed of the panels and with the oscillation speed transversally to the said panels of both heads, the guns of which are now activated for performing simple works, with production outputs that are variable in the average from two to eight or more meters per minute. The two heads now oscillate at the same speed in a synchronous manner.

The features of the invention and its advantages will appear evident from the following description with reference to the figures of the attached drawings, in which:

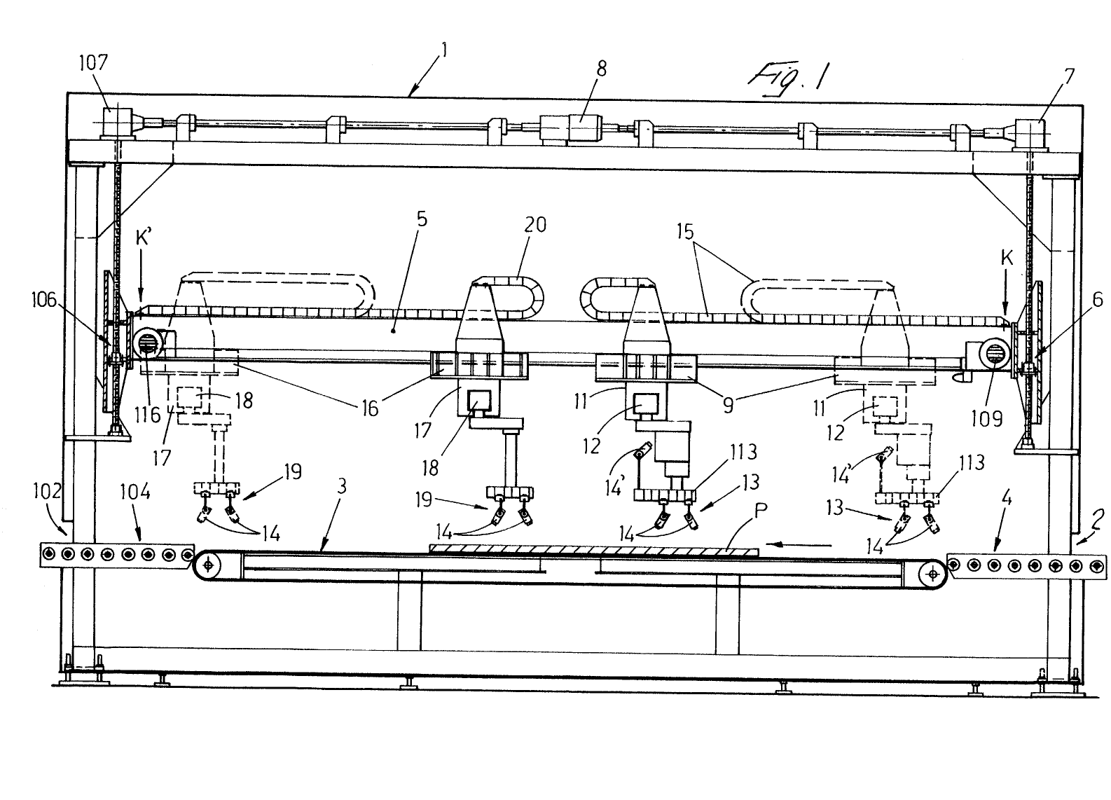

FIG. 1 is a schematic and side elevation view of the machine;

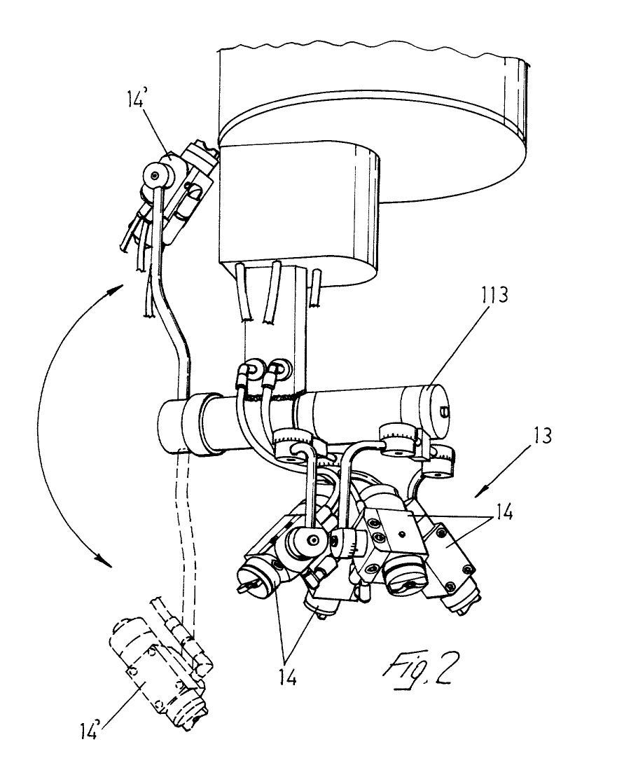

FIG. 2 shows in perspective the disposition of the spray guns on the robotized head.

In FIG. 1, with reference numeral 1 is indicated the booth of the machine, having a length, for example, of about 3-4 meters and provided with openings 2, 102, respectively for the inlet and outlet of the panels, with which openings is aligned a conveyor 3 having at its extremities roller ways 4, 104. With P are indicated the panels to be painted which are introduced into the booth and moved by the means 4, 3, 104 above mentioned. Over such means, parallelly to the direction of advancement of the panels and in the centre line of the booth 1, there is provided a rectilinear and horizontal guide 5 which can regulated in its height position by means of screw and nut screw units 6, 106, connected by means of conical transmissions 7, 107 to a common motorization unit 8 which comprises a motor having an electronic control of the speed and of the phase, because the units 6, 106 provide the regulation of the level position of the robotized spray head and form the vertical axis of displacement or Z axis of the head. The guide 5 forms the Y axis of displacement of the robotized head and upon said guide is mobile a main carriage 9 the position of which is regulated in a known manner by means of a motor 109 with electronic control of the speed and of the phase. Over the carriage 9 there is fixed the middle of a rectilinear guide 11, horizontal and orthogonal with respect to the guide 5, which forms the displacement axis X of the robotized head. Upon said guide 11 is mobile, under control of a motor with electronic control of the speed and of the phase, not illustrated, the secondary carriage 12 which carries, downwardly oriented, the spray head 13 which, under control can be rotated around a vertical axis by means of a motor also not shown, with electronic control of the speed and of the phase. The head 13 comprises for example a horizontal arm 113 as shown in detail in FIG. 2, upon which are assembled with the possibility of adjustable orientation the spray guns 14 for example in the number of four, placed for example substantially on the top of an ideal frustum of pyramid having a rectangular base and oriented with the nozzles in the direction of the corners of said base of the ideal pyramid.

On the arm 113 is also mounted with possibility of rotation around the longitudinal axis of the same arm, a supplementary gun 14′ which by means of a servo control can be carried from the rest position to the working position and vice versa, as shown respectively in FIG. 2 with continuous line and dotted line.

The electric power and the fluids under pressure necessary for the working of the robotized head, are fed from a fixed point schematically indicated with K, placed for example at one extremity of the booth 1 and are supplied to the said head by means of cables and ducts placed in tracked raceways 15 connected to the guides 5 and 11, of which in FIG. 1 is visible only the first.

According to the invention, on the same horizontal guide 5 is mounted longitudinally sliding also a main carriage 16 which carries a guide 17 similar to the guide 11 and parallel with respect to this one, upon which is movable a secondary carriage 18 with an ancillary spray head 19 which carries only the four guns 14 already considered with reference to the FIG. 2 and which does not perform the rotations around a vertical axis and around a horizontal axis like the previous robotized head. A motor with electronic control of the speed and of the phase controls the displacement of the carriage 18 upon the guide 17, while the displacement of the carriage 16 upon the guide 5 is controlled by means of simple type servo control 116, useful to move the same carriage in the position indicated with continues line or in the position indicated with dotted line (see below). With reference numeral 20 is indicated the tracked raceway connected to the guide 5, which carries the electrical cables and the ducts for the feeding from a fixed point K′ of the spray head 19, in combination with an analogous raceway, not illustrated, connected to the guide 17.

The operation of the machine thus conceived is the following:

If the machine has to work on panels of the complex type, the carriage 16 is in the rest position illustrated in FIG. 1 with dotted line and the guns of the ancillary head 19 are inactive. In this case the panels P enter the booth 1, stop at the interior of same in a pre-established position and upon the same panels intervenes the robotized spray head 13, with all the movements of which is capable. The guns 14 of the head 13 will effect the spray painting on the flat surface and on the visible portions of the edges, while the gun 14′ will effect the finish of the complex edges, the whole in a known manner.

If on the contrary the machine has to perform simple works of spraying upon flat panels and with the edges which are all visible, the carriage 16 of the ancillary spray head 19 is carried to an active, fixed and pre-established position, such as for example the one illustrated in FIG. 1 with continues line, while the carriage 9 of the robotized spraying-head is automatically carried and stopped in a variable position, for example in the position indicated with a continuous line in FIG. 1, having a distance from the carriage 16 which is suitably correlated to the speed of travel of the panels inside the booth 1, and to the speed of transverse oscillation to the same panels of both the spraying heads 13 and 19, arranged in such a manner that the sprays effected from the guns of the head 19 intercalate with those executed upon the panel from the guns of the head 13, like in the well-known machines having two oscillating spraying heads, mentioned in the preamble of the present description. In this case the two heads oscillate with an equal speed an in a synchronous manner. If required, the two spraying heads can operate in superimposition and the guns of the two heads can spray different products, for example the first one a quick drying dye or primer, and the second one a paint.

It is clear how the machine according to the invention is capable to perform both complex high-quality works, and simple works, and in this latter circumstance with a great production capacity, with a travelling speed of the panels which is about of eight meters per minute. It is also evident the great economical and practical advantage arising from having assembled into one single machine the productive capacities which up to date were consented only by two separate machines.

1) Machine for the automatic painting of panels or other articles with a simple or complex shape, both in movement and stationary, characterised by comprising a booth (1) provided with means (3, 4, 104) for the longitudinal transport of the panels, at the interior of which booth there is arranged a main painting unit having a robotized head (13), on the guide (5) of which for the longitudinal and vertical movements, is mounted also a main carriage (16) with a guide (17) transversal to the path of the panels, on which there slides a secondary carriage (18) having an ancillary painting head (19), means being provided (116) for the actuation of said main carriage so that, when the machine has to perform complex works with the robotized head (13), on panels inserted and temporarily stopped inside of the booth, said main carriage of the ancillary head (19), is maintained in the rest position, for example at one extremity of the booth, while when the machine has to perform simple works, upon moving panels inside the booth, the main carriage of the ancillary head is carried to an intermediate, fixed and pre-arranged position, inside the same booth and its ancillary spraying head (19) is caused to oscillate transversely to the panels, in combination and in a correct phase with the robotized spraying head (13), the main carriage (9) of which is automatically moved and stopped at a distance from the main carriage (16) of the ancillary head (19), variable and each time correlated to the speed of travel of the panels and to the oscillating speed of the two heads, which both carry aboard guns (14) in a quantity and with a disposition suitable for the combined painting of the panels in movement.

2) Machine according to claim 1, characterised by the fact that the robotized spraying head (13) carries on-board four spraying guns (14) for the performance of simple works, placed for example substantially on the top of an ideal frustum of pyramid having a rectangular base and oriented with their nozzles in the direction of the vertexes of said base of the ideal pyramid and comprising a further gun (14′) which can be moved from a rest position upwardly orientated, to a position downwardly orientated, useful for the finishing of complex edges of the panels, there being provided that the ancillary spraying head (19) is also provided with four guns (14) for the performance of simple works, similarly to what above mentioned regarding the robotized head.
